(19) United States
(12) Patent Application Publication
(10) Pub. No.: US 2009/0050627 A1
(43) Pub. Date: Feb. 26, 2009

(54) Lid weight for a trash receptacle

(76) Inventor: Jimmy Shinault, Virginia Beach, VA (US)

Correspondence Address: WILLIAMS G. SYKES, 3669 SEAGULL BLUFF DRIVE, VIRGINIA BEACH, VA, 23455, US

(21) Appl. No.: 11/894,886

(22) Filed: Aug. 23, 2007

(51) Int. Cl. B65F 1/16; B65D 45/00

(52) U.S. Cl. 220/315

(57) ABSTRACT

A lid weight attachable to a movable lid of a garbage can. While particularly effective with hinged lid cans, the lid weight may be used with any garbage can configurations. When used with hinged lid cans, a single weight is typically sufficient. When used with removable lid cans, pairs of weights are desirable. One or more weights are suspended from a lid by a resilient strap. The downward pressure exerted on the garbage can lid by the attached weight(s) effectively secures the can lid to the can body. The weight(s) effectively lowers the center of gravity of the garbage can, therefore providing resistance to lateral forces, such as those exerted by a crosswind. The novel weight system is readily attachable to any trash, refuse, garbage, or similar container.

### FIELD OF THE INVENTION

The invention pertains to trash receptacles and, more particularly, to an attachment to a trash receptacle lid that both prevents detachment of the lid by wind and, by lowering the center of gravity of the trash receptacle, minimizes the tipping thereof.

### BACKGROUND OF THE INVENTION

The problem of the unintended detachment of garbage can lids by wind is well known and universal. When can lids blow away, their recovery requires time and effort. If the owner of the garbage can fails to recover the lid, the can becomes virtually useless and must be replaced. Replacement of the garbage can presents an unnecessary expense and requires unnecessary effort.

Also, garbage cans may, under windy conditions, readily tip over, especially when empty, or only slightly filled. Because garbage cans are often cylindrical, once tipped over, they readily roll in response to the wind. As garbage cans are often placed along streets and roads for pickup, a rolling garbage can may enter the street or road, thereby presenting a traffic hazard.

### DISCUSSION OF THE RELATED ART

Several attempts to solve one or both of these problems may be found in the prior art. For example, U.S. Pat. No. 4,905,945 for REFUSE CAN STABILIZING APPARATUS AND METHOD AND APPARATUS FOR MANUFACTURE, issued Mar. 6, 1990 to Darryl Peterson teaches a molded concrete stabilizing base for refuse cans and the like. The PETERSON base helps prevent tipping of a refuse can subjected to a lateral force, for example, a crosswind.

Several United States patents show devices for securing a lid to a garbage can. For example, U.S. Pat. No. 4,413,851 for RETAINER STRAP FOR GARBAGE CAN LID, issued Nov. 8, 1983 to Herbert W. Ritter discloses a retaining strap useful for garbage cans having both side handles and a lid handle.

U.S. Pat. No. 4,545,501 for GARBAGE CAN LID RETAINER, issued Oct. 8, 1985 to Daniel DeFord, provides a resilient strap for retaining a garbage can lid.

U.S. Pat. No. 5,758,914 for GARBAGE CAN LID TETHER, issued Jun. 2, 1998 to Joseph Ioveno, shows a flexible tether having an alligator-type clip disposed at each end thereof. A clip at a first end of the tether is readily attachable to any structure on the can lid while the clip at the second end of the tether is readily attachable to any structure on the garbage can body.

U.S. Pat. No. 6,601,726 for DEVICE FOR SECURING A LID ON A CONTAINER, issued Aug. 5, 2003 to Joseph J. Bianco et al., discloses an apparatus having first and second ends adapted to interfit over respective handles of a garbage can. An intermediate portion of the BIANCO device engages the garbage can lid. A securing force is thereby created between the lid and the garbage can.

U.S. Pat. No. 6,880,717 for WASTE CONTAINER INCLUDING A DEVICE FOR SECURING A LID THERETO, issued Apr. 19, 2005 to Thomas F. O'Connor, shows yet another apparatus including a strap having fasteners at each end that are matingly engageable with each other to secure the lid to the container.

U.S. Pat. No. 6,902,081 for GARBAGE CAN LID SECURING SYSTEM, issued Jun. 7, 2005 to Warren Thomas Walker, discloses a lid-securing mechanism particularly useful against animals such as raccoons.

Prior art systems for providing tip-resistance (e.g., PETERSON) are deficient for a several reasons. First, such support bases are sized to accept only a particular diameter garbage can. Such bases are also typically heavy and not readily moved from one location to another. For example, a base located by a structure where a garbage can generally resides, is not readily movable to a curb location where a garbage can is typically placed for pickup. It is often at such a curbside location that a garbage can, particularly after being emptied, is most susceptible to tipping by wind. It is possible, of course, to keep such can-retaining bases permanently located at curbside locations. This may, however, be aesthetically displeasing to a property owner and provide an obstacle to lawn mowing or other grounds keeping functions.

The numerous lid retaining mechanisms discussed hereinabove are completely ineffective in stabilizing a garbage can, particularly when empty. With the exception of the PETERSON '945 patent, none of patents of the prior art, while arguably retaining a lid to a garbage can body, provide any stabilizing (i.e., tip resisting) influence on the garbage can, such as provided by the lid weight of the present invention. PETERSON, on the other hand, neither teaches nor suggests any facility for securing a garbage can lid to the garbage can. Consequently, none of the patents, taken singly, or in any combination are seen to teach or suggest the novel lid-retaining weight of the present invention.

### SUMMARY OF THE INVENTION

In accordance with the present invention, there is provided a lid weight attachable to a removable lid of a garbage can. While particularly effective when used with hinged lid cans, the novel weight system may be used with any garbage can configurations. When used with hinged-lid cans, a single weight is typically sufficient. When used with removable lid cans, pairs of weights are desirable. One or more weights are attached to and suspended from a lid by a resilient strap. The downward pressure exerted on the garbage can lid by the attached weight(s) effectively secures the can lid to the can body. The weight(s) effectively lowers the center of gravity of the garbage can, therefore providing resistance to lateral forces such as those exerted by a crosswind. The novel lid weight system is readily attachable to any trash, refuse, garbage, or similar container.

It is, therefore, an object of the invention to provide a lid weight for attachment to a garbage, refuse, or similar type can.

It is a further object of the invention to provide a garbage can lid weight particularly suitable for use with hinged-lid garbage cans.

It is another object of the invention to provide a garbage can lid weight universally attachable to existing garbage cans.

It is an additional object of the invention to provide a garbage can lid weight that provides a downward force on a garbage can lid sufficient to retain the lid to the can body.

It is another object of the invention to provide a garbage can lid weight that lowers the center of gravity of an empty partially filled garbage can.

It is a further object of the invention to provide a garbage can lid weight that is weather resistant and that provides a long service life.

It is a still further object of the invention to provide a garbage can lid weight that is easy to attach, but which may not readily be inadvertently removed from the can lid.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a top, plan, schematic view of the lid weight of the present invention;

FIG. 2 is a side, cross-sectional, schematic view of the lid weight of FIG. 1; and

FIG. 3 is perspective view of a hinged garbage can with the lid weight of FIGS. 1 and 2 installed thereupon.

### DETAILED DESCRIPTION OF THE PREFERRED EMBODIMENT

The present invention provides a suspended weight attachable to a garbage can lid. When attached to hinged-lid garbage can, the novel weight is typically attached to the edge of the lid opposite the hinge. When used with a non-hinged lid can, one or more weights may be attached to the lid, typically diametrically opposed to each other.

The novel weight system of the present invention overcomes all of the limitations of the prior art devices. The inventive device may readily be retrofitted to existing garbage cans, or may be provided as an inherent part of new garbage cans.

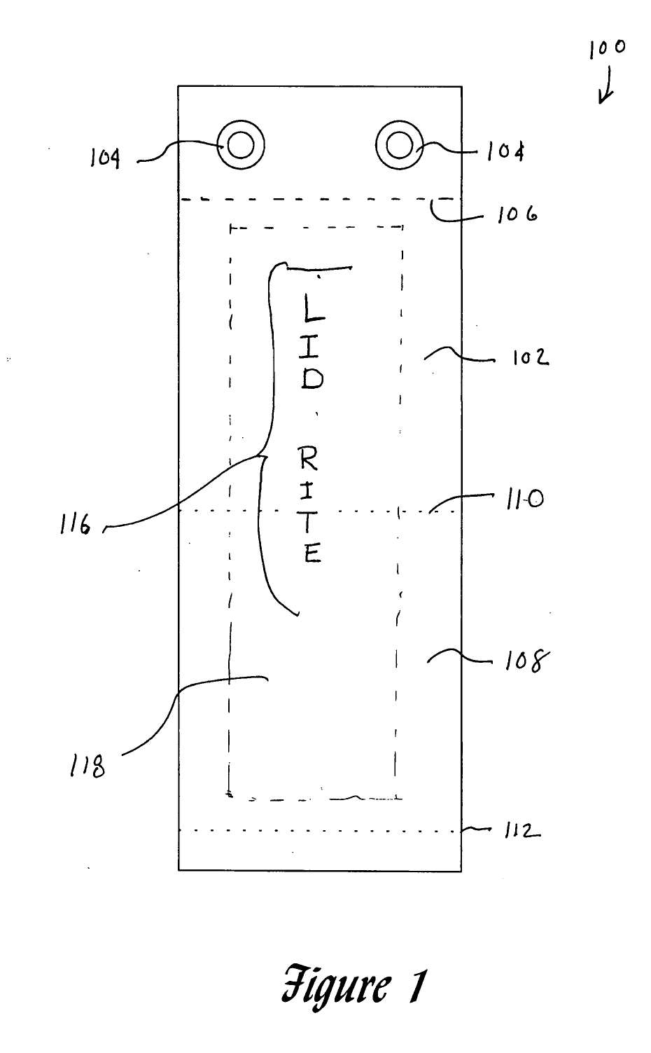

Referring first to FIG. 1, there is shown a top, plan, perspective view of a first embodiment of the lid weight in accordance with the present invention, generally at reference number 100. Lid weight 100 has a body 102 formed from tubular webbing, typically woven Nylon® or a similar substance.

A pair of eyelets 104 are disposed proximate an upper edge of body 102. Typically, eyelets 104 are placed through a double layer of body 102 formed by folding the tubular webbing back upon itself. The two layers are stitched or otherwise fastened to each other using stitching 106. The process and materials required for performing suitable stitching are believed to be well known to those of skill in the art, and are not further described herein. When necessary, a zigzag pattern of stitching may be used for added strength.

A lower region 108 of body 102 is defined by stitching 110. As with stitching 106, a zigzag pattern may be used when required.

Stitching 112 is placed through a doubled back (i.e., folded over) portion of the tubular webbing forming body 102 to close the lower, distal end of body 102. Stitching 112 may also, when necessary, be formed in a zigzag pattern.

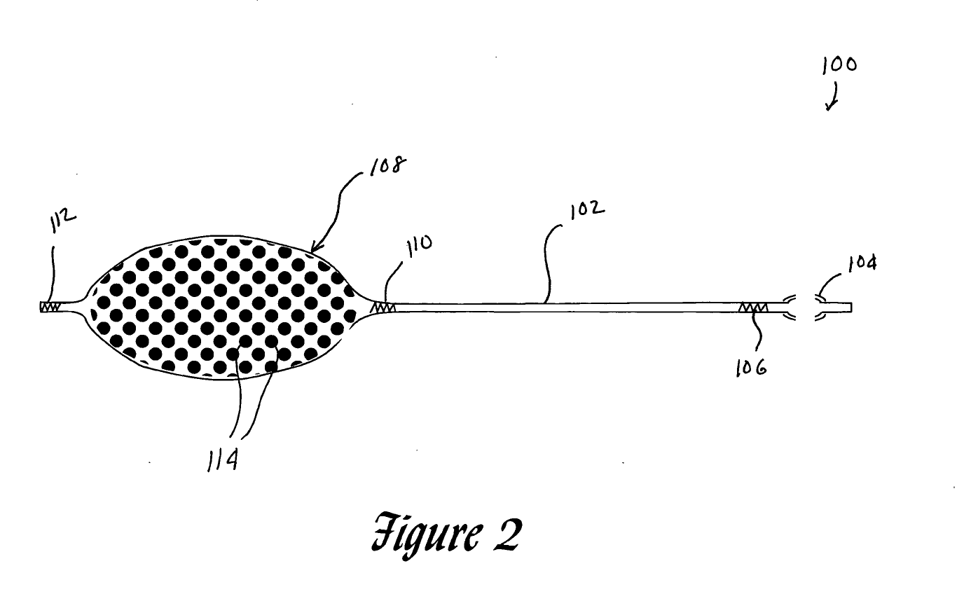

Referring now also to FIG. 2, there is shown a side, cross-sectional, schematic view of lid weight 100. Lower region 108 disposed between stitching 110 and stitching 112 is expanded and filled with weights 114, shown schematically as discrete, spherical particles.

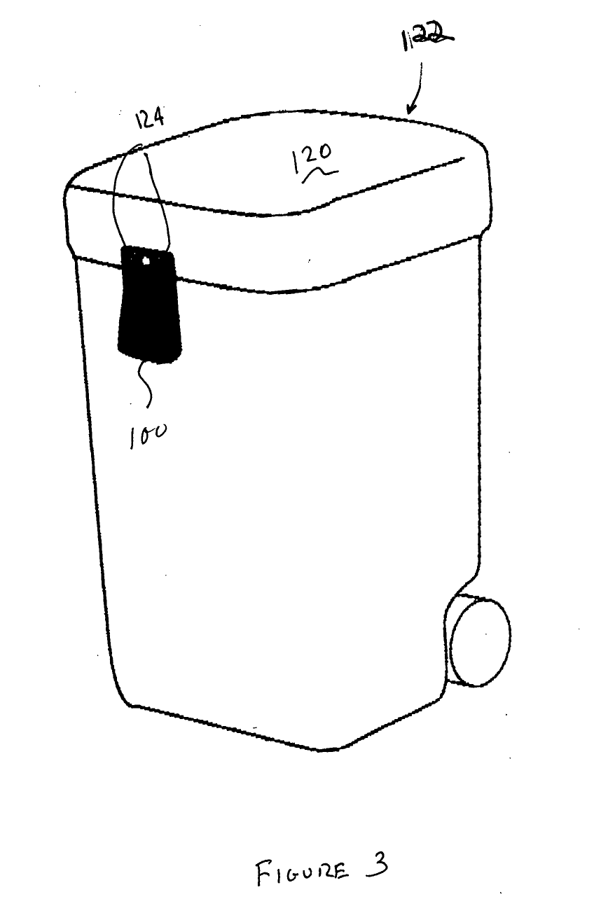

It will be recognized that weights 114 may be implemented in many different ways from a wide variety of materials provided in many different sizes and/or form factors. If a fine, granular material, for example, sand, is chosen for weights 114, an inner bladder, not shown, may be provided to contain the sand. The weight material is preferably, but not necessarily, an environmentally friendly, non-toxic, and weatherproof material. Lead shot could, of course, be used, but lead is toxic. Iron could also be used but is subject to rusting, potentially staining the garbage can 120 (FIG. 3) and the surface upon which garbage can 120 rests. Those of skill in the art can readily select a suitable material for weights 114. The material, size, shape, and form factor form no part of the present invention. Consequently, the invention includes any and all suitable weight materials.

Referring again to FIG. 1, indicia 116 may be placed on an outside face of body 102, typically in a central region 118 thereupon. Such indicia may include graphics, letters, numerals, symbols, etc. For example, weight 100 may be provided with advertising. Lid weight 100 may be customized to include a house or building number, a name, or any other suitable information.

Referring now also to FIG. 3, there is shown an environmental, perspective view of lid weight 100 attached to a garbage can lid 120 in its intended operational position. Weight 100 is disposed on lid 120 opposite a hinged edge 122.

Eyelets 104 may be used for attaching weight 100 to a garbage can lid. Screws, bolts, push-through fasteners, or any other suitable securements, shown schematically at reference number 124 may be used to secure weight 100 to lid 120. Any of the many types of fasteners well known to those of skill in the fastener art may be used.

While the term “garbage can” has been used herein, for purposes of disclosure, it will be recognized that the inventive weight system may be used with any similar container regardless of size or function.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An article for attachment to a lid of a refuse container, comprising:
a) a body comprising tubular webbing having a proximal end, a distal end, and a predetermined length;
b) at least one eyelet disposed in and through said tubular webbing proximate said proximal end of said body;
c) a weight disposed in an interior portion of said body portion proximate said distal end thereof; and
d) means for retaining said weight in position proximate said distal end of said body.

2. The article for attachment to a lid of a refuse container as recited in claim 1, wherein said means for retaining said weight in position proximate said distal end of said tubular webbing comprises stitching through said tubular webbing.

3. The article for attachment to a lid of a refuse container as recited in claim 1, wherein said stitching is disposed through said tubular webbing substantially perpendicular to a major axis of said body.

4. The article for attachment to a lid of a refuse container as recited in claim 2, wherein said stitching comprises a zigzag pattern.

5. The article for attachment to a lid of a refuse container as recited in claim 3, wherein said stitching comprises a first band of stitching proximate said distal end of said body and a second band of stitching disposed between said weight and said proximal end of said body.

6. The article for attachment to a lid of a refuse container as recited in claim 1, wherein said weight comprises a granular material.

7. The article for attachment to a lid of a refuse container as recited in claim 6, further comprising:
e) an inner bladder surrounding said granular material.

8. The article for attachment to a lid of a refuse container as recited in claim 1, wherein said weight comprises a solid object.

9. The article for attachment to a lid of a refuse container as recited in claim 1, further comprising:
e) indicia disposed on an outward-facing portion said of body.

10. A method of retaining a lid on a garbage can, the steps comprising:
a) providing a garbage can comprising a container having a center of gravity and a lid;
b) providing at least one lid weight comprising a body, means for attaching said lid weight to said garbage can lid, and a weight disposed in a lower region of said body;
c) attaching said at least one lid weight said lid of said garbage can;
whereby said lid weight exerts a downward force upon said garbage can lid, and said center of gravity of said garbage can to which said lid is retained is lowered.

11. The method of retaining a lid on a garbage can as recited in claim 10, wherein said providing step (b) comprises providing a lid weight wherein said means for attaching comprises at least one eyelet disposed in an upper portion of said body.

12. The method of retaining a lid on a garbage can as recited in claim 10, wherein said providing step (b) comprises providing a lid weight comprising indicia disposed on a face thereof.
